(19) United States
(12) Patent Application Publication
(10) Pub. No.: US 2016/0067992 A1
(43) Pub. Date: Mar. 10, 2016

(54) Method of Manufacturing Hand Stamp

(71) Applicant: Craig Petersen, Elk Grove Village, IL (US)

(72) Inventor: Craig Petersen, Elk Grove Village, IL (US)

(21) Appl. No.: 14/481,218

(22) Filed: Sep. 9, 2014

(51) Int. Cl. B41K 1/08

(52) U.S. Cl. CPC B41K 1/08

(57) ABSTRACT

A method of manufacturing a hand stamp by assembling a stack of individual stamp pegs. The pegs are attached to each other by tabs and slots so that the individual pegs can be easily separated from each other. A sheet of rubber like material has characters on the sheet. The individual characters are separated from each other by a small bridging portion of the rubber like material. The sheet of rubberlike material is then adhesively attached to the top of the stack of stamp pegs. The individual pegs can then be separated from each other and re-assembled to form a hand stamp with the desired characters forming words or other information.

### BACKGROUND AND SUMMARY OF INVENTION

This invention relates to hand stamps and particularly to hand stamps that use a plurality of pegs or rectangular solids with various indicia contained on and end to create a hand stamp. In particular this invention relates to the method of manufacturing the hand stamp.

Various types of hand stamps have been used in the past. Most of them have used a frame that holds various types of printing plates that have the printing indicia thereon. The printing plate may be permanently mounted in the stamp or can be changed. An example of one that allows the printing plate to be changed is illustrated in U.S. Pat. No. 2,899,895 issued to Tannery. However, a shortcoming of this device is that it uses a frame to hold the individual printing plates.

Other types of hand stamps that have printing plates or individual characters changes are illustrated in U.S. Pat. No. 6,098,535 that allows the entire printing plate or surface to be changes, and U.S. Pat. No. 3,631,799 that allows individual stems to be replaced.

Another type of hand stamp uses the individual pegs, each peg having a printing surface at one end, with a character or printing indicia at the printing end. By joining together a plurality of these pegs, a hand stamp is formed. No frame is required to hold the pegs with the printing indicia thereon as the pegs form the stamp that is held by the user to create the stamping impressions.

Applicant's invention provides a method of manufacturing the hand stamp that uses the individual pegs to create the final hand stamp. Applicant provides a plurality of pegs joined together to form a stack or grouping of pegs. A sheet of rubber material having the printing indicia thereon is placed over the stack of pegs and glued to the top of the pegs as an entire sheet. The individual characters that are on the sheet are connected together by a thin bridge of material that is intended to be torn apart or ruptured when the individual pegs are disassembled from the stack for creating the individual pegs that are connected to create the final stamp.

### BRIEF DESCRIPTION OF THE DRAWINGS

FIG. 1 is a perspective view of a plurality of individual character pegs joined together to form a stack of pegs.

FIG. 2 is a perspective view of the stack of pegs with one column of three pegs separated from the stack.

FIG. 3 is a left side view of an individual peg with the rubber character attached to the top of the peg.

FIG. 4 is a front view of an individual peg with the rubber character attached to the top of the peg.

FIG. 5 is a right side view of an individual peg with the rubber character attached to the top of the peg.

FIG. 6 is a rear view of an individual peg with the rubber character attached to the top of the peg.

FIG. 7 is a top plan view of the sheet of rubber like material with portions removed showing the indicia cut therein and showing the interconnecting bridges.

### DESCRIPTION OF THE PREFERRED EMBODIMENT

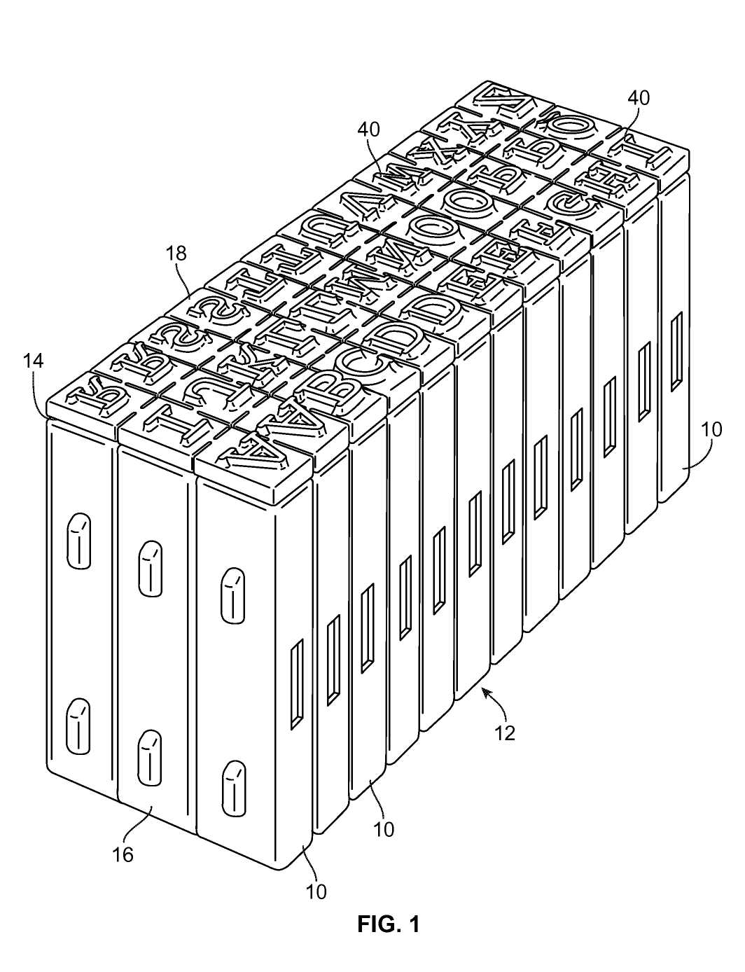

Turning first to FIG. 1 there is illustrated a plurality of individual pegs 10 that are connected together to form a stack of pegs 12. The individual pegs 10 are preferably made of a plastic material that can be easily and quickly manufactured using conventional plastic forming machinery. As seen in FIG. 1, the preferred shape of the individual pegs 10 is a rectangular solid, however solid shapes can be used. The pegs 10 have a flat top surface 14 and a flat bottom surface 16. On the top surface 16 is a sheet of rubberlike material 18 that is commonly used in the stamp industry for forming the printing indicia.

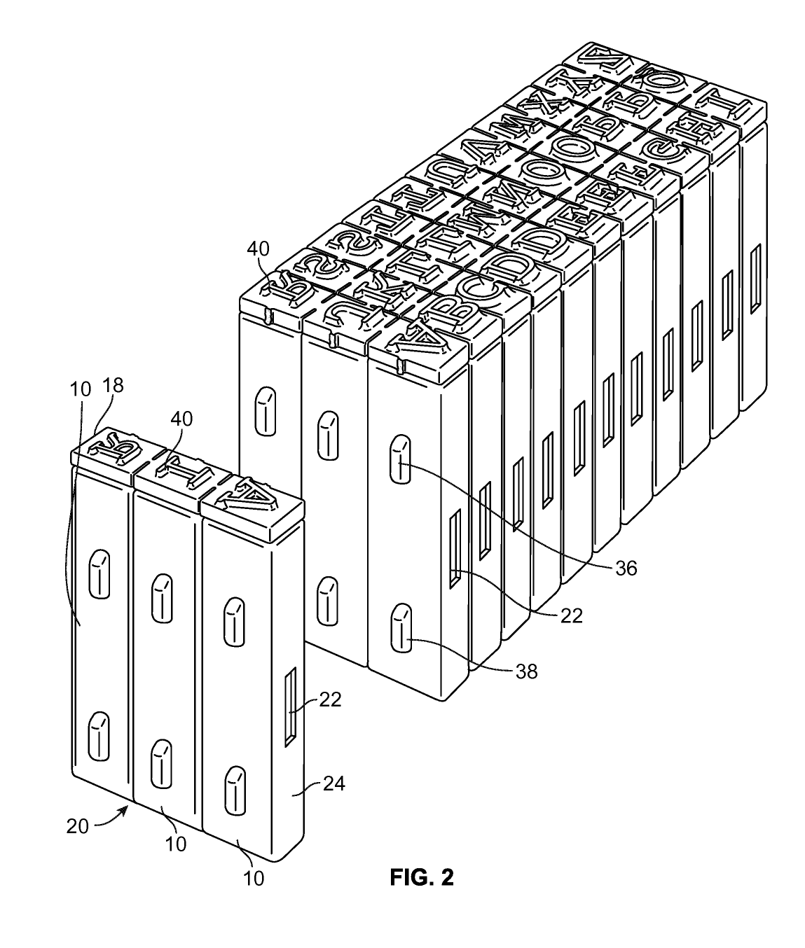

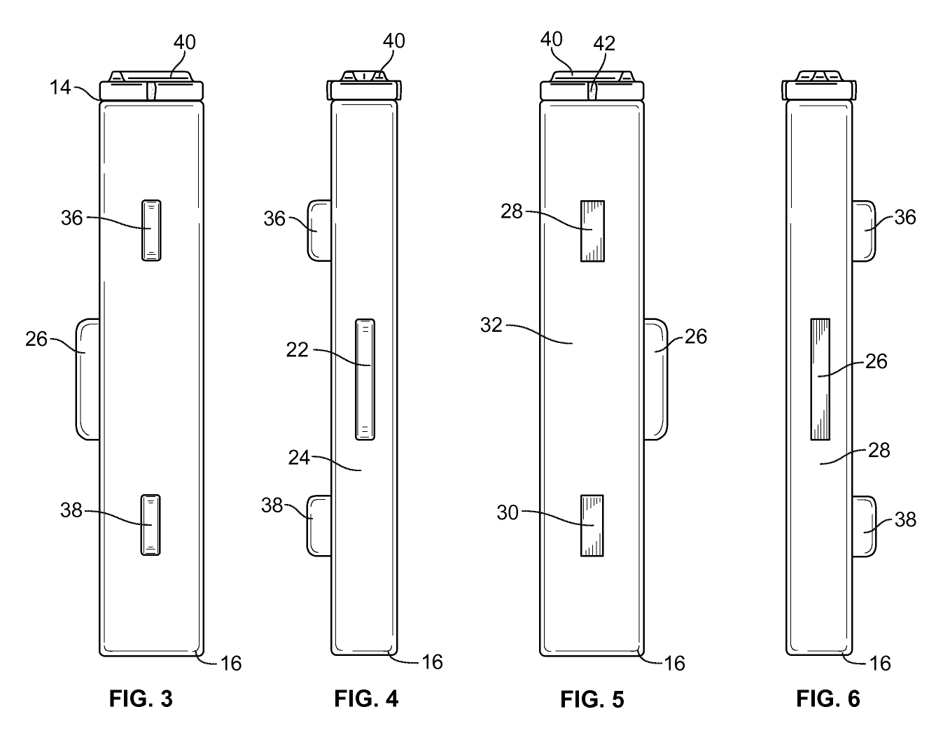

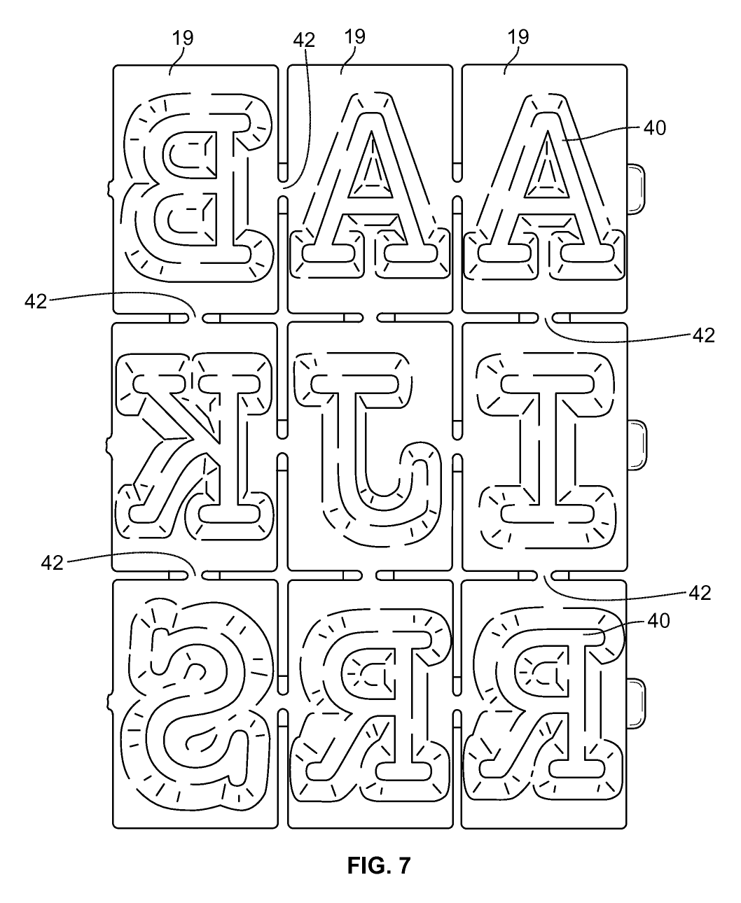

The individual pegs 10 are joined together but can be easily separated as seen in FIG. 2. Three pegs 10 have been separated from the stack 12 forming a column 20 comprised of the three pegs 10. The individual pegs 10 have a slot 22 formed in a front 24. There is a rear tab 26 formed in a rear portion 28 of the peg 10 as illustrated in FIGS. 4 and 6. Similarly there is a pair of side slots 28, 30 on a rights side 32 of the peg 10 (FIG. 5.) A left side 34 of the peg 10 has a pair of left tabs 36, 38 (FIG. 3.) The tab 26 is received in a frictional fit in the slot 22 and the tabs 36, 38 are received in a frictional fit in slots 28, 30. In this manner the pegs 10 can be stacked together and held in place by tabs that are received in their respective slots. To separate a peg from an adjacent peg, the user must merely pull an individual peg apart from its adjacent peg or pegs.

On the top 14 of each peg 10 is an individual piece 19 of rubberlike material 18 that has a number, letter or other indicia thereon. In the prior art, these individual pieces of rubberlike material 19 were individually glued on to the top 14 of each peg 10. Obviously this is extremely labor intensive and not subject to exact precision as the laborer may place a piece of rubberlike material 19 at an angle with respect to the sides of the peg. In the previous manner of assembling the pegs, the pegs 10 had their individual piece 19 of rubber like material glued onto the top 14 of a peg 10 and the plurality of pegs 10 were then joined into stacks 12. Alternatively a stack 12 of pegs 10 was assembled and the individual pieces of rubberlike material with indicia thereon were glued onto the tops 14.

Applicant's invention comprises a new method of attaching the rubberlike material 18 to the top 14 of the pegs 10. First, a sheet of the rubberlike material is selected. The size is preferably selected so that it can be cut into individual groups of letters or numbers that will be the same dimension as a stack of pegs. Generally a convenient size is that of A4 paper, namely 29.7 cm×21 cm. The sheet of rubberlike material is then laser cut on its top surface so that a plurality of numbers, letters, symbols, and other printing indicia 40 are formed in the top surface. The indicia 40 is raised on the surface of the rubberlike material so that when ink is applied, the ink can be transferred from the raised portion to a receiving medium when the raised portion is pressed into contact with the receiving medium.

As clearly seen in FIG. 7, each of the indicia 40 is created on a substantially rectangular individual piece 19. Each of the individual pieces 19 are connected by a thin piece of the rubberlike material or bridge 42 that was not cut away during the laser cutting operation. The rest of the rubberlike material between the individual pieces 19 is cut away during the laser cutting operation. Thus, the bridge 42 is the only connection that keeps the individual pieces 19 connected to each other. Once the grouping of individual pieces 19 with the desired indicia is created, such as seen in FIG. 1, the grouping is cut from the entire sheet. The size and number of individual rectangular pieces 19 that will make up the grouping will be selected so that it equals the size of the stack 12. For example, if one decides to have a stack as seen in FIG. 1, there will be a matrix of 12 pegs across by three pegs deep with a total of thirty-six pegs. Likewise, there will be a sheet of rubberlike material with thirty-six rectangular pieces 19 in the same orientation of 12 across by three deep. The bridges 42 will be aligned with the separation between the pegs 10.

An alternate method to make the indicia on the sheet of rubberlike material is known in the art. This process involves making a photo engraving of the desired indicia. The photo engraving is a metal plate consisting of a “relief” or raised reproduction of the indicia. This is used to create a mold. The sheet of rubberlike material is placed on top of the mold, and both the sheet and mold are placed in a heated press. The rubber melts into the recessed areas of the mold, and allowed to cool. The rubber hardens and the sheet is then stripped off of the mold. The sheet of rubberlike material can then be mounted on a thin layer of sponge cushion. The laser cutting operation as described above separates the individual pieces 19 from each other while leaving the bridges 42 between adjacent pieces 19.

Once the grouping of individual pieces is created, it is laser cut from the larger sheet of rubberlike material. A layer of adhesive is then applied to the back surface of the grouping of individual pieces. This layer of adhesive may be covered by a protective layer of paper or similar material. When the sheet of rubberlike material is to be attached to the top 14 of the pegs 10, the protective layer of paper is removed and the adhesive surface is exposed. The back surface is pressed against the tops 14 of the stack which causes the sheet of rubberlike material to adhere to the tops 14. The stack 12 is completed with the individual pieces 19 placed on the tops 14 of the pegs 10.

To use the individual pegs 10 to create a hand stamp, the user first decides with of the individual pegs he needs. Then the pegs with the proper printing indicia are selected and the pegs 10 are pulled apart from each other. The bridges 42 connecting adjacent pieces 19 rupture as they are thin and easily ruptured. This releases a peg 10, with its printing indicia thereon, from adjacent pegs 10. The user re-assembles the selected pegs 10 using the tabs 36, 38 being re-inserted into the respective slots 28, 30 to form the hand stamp with the desired indicia on the tops 14. The individual pieces 19 forming the stack 12 are placed against an ink pad where they are inked and ready to be applied against the receiving media. The rectangular solid pegs 10 that form the stack 12 are easily held by the user to create the stamping impressions.

Thus there has been provided a method of manufacturing a hand stamp that uses individual pegs with printing indicia thereon. While the invention has been described in conjunction with specific embodiments, it is evident that many alternatives, modifications and variations will be apparent to those skilled in the art in light of the foregoing description. Accordingly, it is intended to embrace all such alternatives, modifications and variations as fall within the spirit and scope of the appended claims.

What is claimed is:

1. A method of making a hand stamp comprising the steps of:
a. providing a sheet of rubber like material having a top and bottom surface,
b. forming a plurality of adjacent character indicia on the surface,
c. removing the rubber like material between the adjacent character indicia while leaving a bridging piece of rubberlike material between the adjacent character indicia, and
d. attaching the sheet of rubber like material to a top surface of a plurality of interconnected stamp pegs.

2. The method of claim 1 and the further step of removing portions of the top surface of the sheet of rubber like material to form the adjacent character indicia on the surface.

3. The method of claim 1 and the further step of forming the desired adjacent character indicia on the surface by forming a mold, placing the sheet of rubberlike material over the mold and applying heat and pressure to the sheet of rubberlike material to melt the rubberlike material onto the mold.

4. The method of claim 3 and the further step of allowing the sheet of rubberlike material to cool and stripping it from the mold.

5. The method of claim 1 and the further step of applying an adhesive to the bottom surface of the rubber like sheet for attaching the rubber like sheet to the top surface of the interconnected stamp pegs.

6. The method of claim 1 and the further step of applying an adhesive to the top surface of the interconnected stamp pegs for attaching the rubber like sheet to the top surface.

7. The method of claim 5 and the further step of applying a removable protective cover over the adhesive and removing the protective cover prior to attaching the sheet of rubber like material to the top surface of the interconnected pegs.

8. The method of claim 1 and the further step of using a laser for removing portions of the top surface of the sheet of rubber like material.

9. The method of claim 1 and the further step of applying a double sided adhesive tape to the bottom surface of the rubber like sheet.

10. The method of claim 1 and further providing a plurality of interconnected stamp pegs of the same size as the sheet of rubber like material for receiving the sheet of rubber like material.

11. The method of claim 10 wherein the character indicia are formed in rectangular pieces that are separated by each other by spaces but interconnected to adjacent pieces by a bridging piece of rubber like material.

12. The method of claim 11 wherein the characters are formed in rectangular pieces that have dimensions substantially equal to the dimensions of the top of the individual stamp pegs.

13. A method of manufacturing a hand stamp comprising the following steps:
a. providing a plurality of individual stamp pegs that are assembled in a stack of interconnected but separable pegs, the stamp pegs having a top surface;
b. providing a sheet of rubberlike material of a selected size having a top and bottom surface;
c. forming a plurality of adjacent characters on the top surface;
d. removing substantially all of the rubber like material between the adjacent characters while leaving a bridging piece of rubberlike material between the adjacent characters, and
e. attaching the sheet of rubberlike material to the top surface of the plurality of interconnected stamp pegs.

14. The method of claim 13 and the further step of removing portions of the top surface of the sheet of rubber like material to form the adjacent characters on the surface.

15. The method of claim 13 and the further step of forming the desired adjacent characters on the surface by forming a mold, placing the sheet of rubberlike material over the mold and applying heat and pressure to the sheet of rubberlike material to melt the rubberlike material onto the mold.

16. The method of claim 13 and the further step of applying an adhesive to the bottom surface of the rubber like material for attaching the rubber like material to the top surface of the interconnected stamp pegs.

17. The method of claim 13 and the further step of applying an adhesive to the top surface of the interconnected stamp pegs for attaching the rubberlike sheet to the top surface of the interconnected stamp pegs.

18. The method of claim 16 and the further step of applying a removable protective cover over the adhesive and removing the protective cover prior to attaching the sheet of rubber like material to the top surface of the interconnected pegs.

19. The method of claim 13 and the further step of using a laser for removing substantially all of the rubber like material between the adjacent characters while leaving a bridging piece of rubberlike material between the adjacent characters

20. The method of claim 13 wherein the characters are formed on rectangular pieces that are separated by each other by spaces but interconnected to adjacent rectangular pieces by a bridging piece of rubber like material.
